(19) United States
(12) Patent Application Publication
(10) Pub. No.: US 2022/0375309 A1
(43) Pub. Date: Nov. 24, 2022

(54) Arrangement of electronic elements to optimize user management in the online betting market

(71) Applicant: Israel Piñero Mas, Madrid (ES)

(72) Inventor: Israel Piñero Mas, Madrid (ES)

(21) Appl. No.: 17/749,192

(22) Filed: May 20, 2022

Related U.S. Application Data
(60) Provisional application No. 63/190,831, filed on May 20, 2021.

(51) Int. Cl. G07F 17/32

(52) U.S. Cl. CPC G07F 17/3288; G07F 17/3239

(57) ABSTRACT

An arrangement of interconnected electronic elements to guide and help within the online betting market comprising four main elements interconnected electronically and configured within a web, where the main elements would be: at least one or more users called bettors (bettor 1, bettor 2, bettor 3. bettor N.), each with their respective connection device to the Betting's house, related bank accounts, with the events that are the object of the bets, all classified within the same website, a betting house. (betting 1, betting 2, betting N), each with its connection device to the bettors, connection to the banks and connection to the events that are the object of the bets, all within the same website, a betting house's bank, an account in the bank.

### CROSS-REFERENCE TO RELATED APPLICATIONS

This application is a non-provisional application for provisional patent application U.S. 63/190,831

### STATEMENT REGARDING FEDERALLY SPONSORED RESEARCH OR DEVELOPMENT

Not applicable

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATION-BY-REFEENCE OF MATERIAL SUBMITTED ON A COMPACT DISC

Not applicable

### BACKGROUND OF THE INVENTION TECHNICAL FIELD

### Field of the Invention

The field of the invention is that of electrical arrangements or processing means for the performance of any automated operation using empirical data in electronic form for classifying, analyzing, monitoring, or carrying out calculations on the data to produce a result or event.

### Description of Related Art

This application claims priority to and the benefit of the non-provisional patent application titled “A system and software product for online betting”, application No. 63/190,831, filed in the United States Patent and trademark Office on May the 20, 2021. The specification of the above referenced patent application is incorporated herein by reference in its entirety.

To date, the market only offers partial information that is focused or reduced to indicating which bookmaker offers the best odds

There are also some operators on the market whose only function as notification is reduced to goals or scorers. Once we open them we can see: event statistics, line-ups, classification and team form.

On the other hand, bookmakers do not offer a complete alert service in many markets, not to mention little or almost none or non-existent. It is required to watch the event or enter some kind of live device to follow your bets. Which is uncomfortable, stressful and exhausting, combined devices and resources.

This is where the invaluable and indispensable contribution of the arrangement that the invention advocates lies, no one offers such a complete arrangement connecting bookmakers with users who bet.

### BRIEF SUMMARY OF THE INVENTION

The purpose of the patent is to create an “online” and real-time communication between a betting user and the gambling houses, the banks associated with the users and the gambling houses, and in many cases with the game on which that user is playing.

There are secondary connections with other collateral elements such as tipsters, external surveys and playing fields.

### BRIEF DESCRIPTION OF THE DRAWINGS

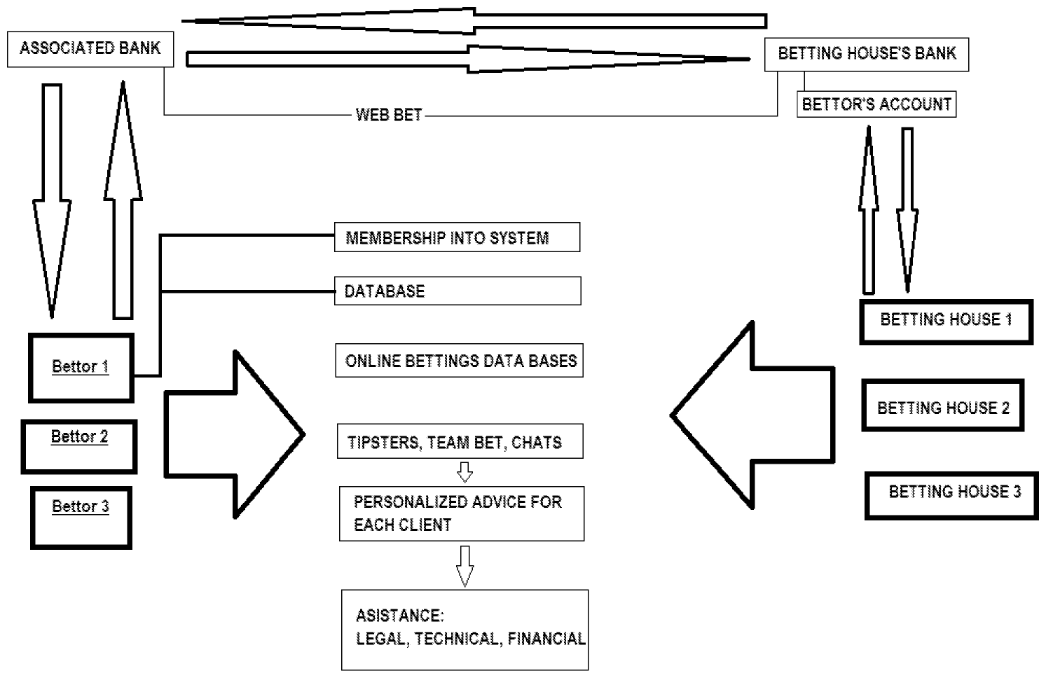

For a better understanding of the invention, a sheet of plans is provided where in FIG. 1 the elements that make up the arrangement and the relationship between them can be seen.

### DETAILED DESCRIPTION OF THE INVENTION

It is an arrangement of interconnected electronic elements as a guide and help within the gambling and betting market, to help the user and facilitate its management by optimizing its possibilities of analysis, data and success, offering notifications of any bet that has been made without the need to carry out additional management, activating notifications and warnings.

It also allows you to obtain a large amount of information on any market and type of bet in real time, it will connect the user with their accounts, the different gambling houses and the bets they have made.

Everything will be computerized, registered, detailed and a personalized report will be created for the user, in the desired period of time.

It is designed and admits any type of client or bettor, beginner, medium, professional, occasional . . . . In the same way, it can be used in “alert mode” for those people who play a very low amount for fun or who simply do not bet but they show interest in staying informed while maintaining user privacy.

Different versions of the provision may be available depending on the evolution of the market and the rate of downloads or funds that ensure its sustainability and profitability. In the hypothetical case of offering paid versions, they could be based on various aspects or variables such as the amount to be paid, the period of time, etc. There will be various modalities:
free version, which may or may not include the advertising option to support the application, with all or part of the available functions. Obviously it is very feasible that some will be diminished, but it is not definitive or there is certainty
PRO version: Hosting the majority of usage options, which will improve
PREMIUM version: the most complete version, with the option to avoid advertising.

The variety of options offered by the layout is configurable, therefore the aim is to satisfy the client as much as possible.

We will receive the notices, notifications or advice that we establish or that come by default.

Certain standard modes will be offered to work, fully configurable, but you can create your own and assign a name to it so that it remains saved, and modifications can be made at any time.

It is very likely that the users part will configure each mode or opt for a custom configuration. To facilitate this work, a virtual assistant and video will be available as an explanatory tutorial.

Various modes will be available depending on certain criteria, editable and combinable, such as: type of notices, betting approach, etc. . . . .

Here are some examples:

| | BETTING | |
|---|---|---|
| TYPE | APPROACH | DESCRIPTION |
| a | FUN | We have users who do not bet only follow the |
| | | results and statistics of sporting events. |
| | | Information on betting management by default |
| | | is overridden |
| b | RANDOM | No assigned market, no budget or quantities, |
| | | only announcements to any market that is bet. |
| | | Logically by default there will be few warnings or |
| | | management recommendations. Daily profit or |
| | | loss notices, withdrawal or deposit |
| | | recommendation and little else |
| c | ROOKIE | When there is already a defined way to proceed |
| | | in betting, a different pack of measures and |
| | | help will be offered. |
| d | BETTOR | When establishing certain settings and betting |
| | | style that this tool will describe. Greater detail |
| | | of alerts and warnings. |
| e | BETTOR | Here we go to one of the highest levels of |
| | PRO | operation by default. As always editable. |
| f | EDITABLE | Fully edited and configured by user, with the |
| | | possibility of assigning a name or title. |
| TYPE | MODES | DESCRIPTION |
| a | Cascade | Receiving all notifications as pop-up balloons |
| | mode | on the cell phone, described throughout this |
| | | document |
| b | Selective | By consciously selecting which part of our bets |
| | mode | we want to know in real time through notices |
| c | Incognito | Making use of the possibility of having all the |
| | mode | specific information of our bets and results in |
| | | our personal notification tray when accessing |
| | | the web or app. |
| d | Invisible | If at any time we want to simply disconnect and |
| | mode | not receive notifications |

The provision would have the possibility of offering several versions depending on what is most comfortable for the client, offering versions in order to cover all devices on the market, such as: IOS, Android, tablets, computers, Smart TV, smart watches . . . etc. Feature adjustments will be made for some more limited devices.

It will also remain connected to the customer's email or other similar digital resource, to ensure and guarantee a more fluid and effective communication.

Another of the strengths of this provision of customer service will be the availability of various variants such as: telephone help service, live chat, computerized or personal customer service, through the web with its own messaging service, or use the more frequent and successful

It will have several modes of operation. Autonomously and independently, without considering previous agreements with bookmakers, at the user level it will remain connected to bookmakers to obtain data.

It will probably require the password in each bookmaker to be able to register and deal with the user's accounting. In addition to the possibility of having a technical team that updates the data center.

On the other hand, in collaboration with houses or agreements, it would add a plus to the operation and data in real time or even with a certain forecast.

The provision could be connected, prior agreement, with the bookmakers to interact jointly and offer data and information in real time to the user, something new and with great potential in this great market. Providing endless options that no option to date provides, such as:

a.—It makes it easier to develop a betting system or mode, it asks you for an amount (bank) and suggests what you should bet on each occasion (stake) or even the number of tipsters you follow (tipsters) or the number of daily bets. Structure your investment, a luxury for any user, especially for neophytes or inexperienced users. Always maintaining user privacy.

b.—It informs you in real time of the variations and fluctuations of the markets in which you register your bets. If they go up or down, it indicates the options or probabilities of success. Obtaining privileged information when deciding whether or not to continue with a bet, or buy back if there is an increase in the quota. Work in favor of the user without rest

c.—Option to divide or categorize your bets by: markets, tipsters, odds . . . etc. Obtaining a detailed record of results in the selected space and time. Undoubtedly very useful and essential to obtain conclusive results of strengths and weaknesses, making it possible to redirect our structure or continue to trust it. Many forecasters falsify their results,

d.—Possibility, prior agreement with bookmakers, at the same time that you make bets, categorize them in some way in an instant and automatic way, by touch or by voice connected to the system in real time.

e.—Offer voice or manual mode to categorize bets, select predictor, market . . . and by voice type of bet with its details and you could select predictor and link our bets made to that category, by clicking or speaking by voice

f.—Analysis of results in a certain period of editable time (profit/loss) receiving notification or entering the system. It can be broken down by markets, tipsters, odds or quantity and more factors. You can create an Excel sheet or similar format in a personalized way. Bookmakers only send winning bets live or allow you to select a period for general delayed results. Nobody offers such a detailed and objective record that allows the user to observe their roadmap and make decisions vital to success.

g.—Offer in detail, according to the selected period, a favorable balance or not of benefit, of amounts invested, of what is necessary to recover capital in case of losses, recommend odds or recovery bets or simply recommend waiting for the next period of time. The normal thing for gamblers of a certain level is to go for months or years.

h.—It connects to all the bookmakers in which we are registered, whether we operate or not. This saves us the tedious work of having to calculate profit and loss in a given time interval. It is usually the case that many users place their bets in different houses and/or distribute them for different reasons

i.—Different operating modes. It is common knowledge that the bettor is not always available to receive and manage instant data. Therefore, the provision will allow managing notifications and warnings in different ways:

| TYPE | MODES | DESCRIPTION |
|---|---|---|
| a | Cascade | Receiving all notifications as pop-up balloons |
| | mode | on the cell phone, described throughout this |
| | | document |
| b | Selective | By consciously selecting which part of our bets |
| | mode | we want to know in real time through notices |
| c | Incognito | Making use of the possibility of having all the |
| | mode | specific information of our bets and results in |
| | | our personal notification tray when accessing |
| | | the web or app. |
| d | Invisible | If at any time we want to simply disconnect and |
| | mode | not receive notifications |

It should be noted that all available modes can be selected and modified at the customer's preference, at any time and with immediate effect, providing a very wide and adaptable configuration to the needs of each user and moment of each day. Some other mode or function may be added and made available during the development and operation of the system

j.—Different modality of notifications according to bets and markets. These are one more option of the novelty of this arrangement whose software adapts to all types of betting and type of market. It is designed for the most tedious bets to follow, such as: handicaps, corners, overs or unders . . . etc.

| | SPECIFIC | |
|---|---|---|
| | ALERT | |
| | TYPES | Description |
| a | Final Mode | Final mode It means that it is the basic alert when |
| | | complete or conclude our bet |
| b | Limit Mode | Limit mode It informs of each step of our bet that is |
| | | taking place: corner, card, goal, throw-in, shot, |
| | | handicap, etc . . . |
| c | Stopwatch | Stopwatch mode When we are just one step away from |
| | Mode | getting a bet, we are missing a card, corner, shot. |
| d | Intermediate | Intermediate mode When half of our bet is fulfilled, |
| | Mode | it informs us, for users who want a moderate level of |
| | | warnings. |

k.—Detailed study of the type of bets with greater or lesser success, as a thread to follow and try to produce a high peak or a path to follow or avoid, with freedom to be configured or selected.

l.—Contribution of more notable statistics is another powerful asset that the system offers us in different markets. It anticipates us and facilitates the necessary search for information in its preview section, before selecting our bets. It applies for simple or combined. The forecast section will be in the same way in some markets, where our experts will make their forecasts on possible bets with odds. Another variant would be the movements section, where in all the markets we would be aware of any significant change in odds, and it would be a great opportunity to place bets or cover ourselves if we have made a bet in any of those sectors.

m.—Report in real time of markets and bookmakers that close markets. The system will also inform us of which houses have closed and which have not. We need to ask about that bet or have made it. If it is due to falling odds, it is essential to be able to place your bet with immediate effect.

n.—Notice of Rule 4 (less is paid for that bet than what is established when making it). This often happens in certain markets such as racetracks when a rider is declared to be retiring. You do not need to have to enter your betting app or website to review or be surprised. If the app is made, it will notify you as soon as it is official.

o.—Constant report of best guaranteed odds

In certain markets there are BOG (best odds guaranteed). Above all, in those that offer a market for large quotas such as greyhounds or horses, it is pure gold. Since if we bet on a certain quota and it rises before the event, profits are recalculated at that higher price. The provision informs us about all the bookmakers and their offer in this regard. It can be activated or deactivated depending on whether or not it has an impact on the market of our bets.

p.—Alert about new bookmakers

Faced with such an emerging market, it is essential to be aware of these new possibilities. And everything they offer us, bonds, markets, etc. . . . .

p.—Notices to avoid restrictions

It is very much the order of the day, that after a good or bad streak or some inconvenience, problems can begin in your account. The platform will make certain recommendations, such as: not to bet more that day, not to withdraw profits immediately . . . etc.

q.—Recommendations on bets

If it detects that we are betting outside our system or roadmap in excess, it will put us on alert. Discipline is essential to achieve profit. This option, like all others, can be activated or deactivated, depending on the user's interests and will depend on what is established as the betting method. For example, if our market is tennis, and one day without being part of our particular system there is a large sum to another sport

r.—Individual or group bettor chat

Nothing to do with that of the bookmakers, here there will be a service of teleoperators who will analyze the cases and try to advise and guide the user for better performance or optimization of bets if feasible. They will also watch over possible gambling or significant losses, encouraging the cessation of activity, always as advice.

s.—Legal assistance

In the face of certain unpleasant situations, such as: restrictions, limitations, gambling addiction classification, deposit or withdrawal problems, blocking of accounts or any type of inconvenience, the provision would offer legal information and possible procedures or solutions. The option of representing the user and managing his situation before the companies in the sector would even be considered.

t.—The provision welcomes novice or expert tipsters from any market or country who submit verified statistics and seek to gain a foothold in the market. There is also the possibility of forming a team of company forecasters who publish their bets for affiliates. The provision offers them a portfolio of users and potential clients, as long as they meet a series of requirements and conditions for our users, our most precious value. Their results will be public for customers to decide. Always legally and transparently

BET APP FORECASTS

| VARIANTS | MODES | DESCRIPTION |
|---|---|---|
| 1 | BET APP | A company team will be formed in |
| | TEAM | certain markets, upon subscription |
| 2 | NOVICE | It will lead to new potential tipsters |
| | | trying to gain a foothold and make |
| | | themselves known, after testing the |
| | | system showing potential. There will |
| | | be certain prerequisites, watching |
| | | over the user |
| 3 | EXPERT | The doors will be opened to certain |
| | | tipsters who choose to join and publish |
| | | on their own. They must meet certain |
| | | conditions with the company, of course. |
| | | They will be able to increase their |
| | | reputation and gain followers from here, |
| | | presenting verified statistics |
| 4 | COMPETITION | There will be events for people who |
| | | want to get involved in a tipsters test, |
| | | both for a specific time or springboard |
| | | to take a leap in the profession. With |
| | | raffles, prizes, etc . . . |

u.—Finally, a series of icons, emojis or visual effects connected to the world of betting would be created, which would arrive together with the warnings or notifications. Obviously they would have a great relationship with the emotion of the moment based on the benefit or loss, giving color and a touch of humor and visual power to each interaction between the system and the user.

In general, the provision will be available to receive notifications of any market and betting variant available to bookmakers that operate in the country in which you live, or perhaps you can work globally or worldwide. To date, the possibility of being notified in real time of many markets is very limited. With the arrangement of the invention, an immense range of being aware of everything related to our bets opens up.

### Preferred Embodiment of the Invention

The object of the invention is to create an “online” and real-time communication between a betting user and the gambling houses, the banks associated with the users and the gambling houses, and in many cases with the game on which that user is playing. bet itself.

There are secondary connections with other collateral elements such as tipsters, external surveys and playing fields.

It is an arrangement of interconnected electronic elements as a guide and help within the gambling and betting market, to help the user and facilitate its management by optimizing its possibilities of analysis, data and success, offering notifications of any bet that has been made without the need to carry out additional management, activating notifications and warnings.

It also allows you to obtain a large amount of information on any market and type of bet in real time, it will connect the user with their accounts, the different gambling houses and the bets they have made.

Everything will be computerized, registered, detailed and a personalized report will be created for the user, in the desired period of time.

In a more precise way, the provision of interconnected electronic elements as a guide and help within the gaming and betting market is made up of four main elements interconnected electronically and configured within a web.

The main elements would be:

.—Bettors. (bettor 1, bettor 2, bettor 3 . . . bettor N.), each with their respective connection device to the Betting's house, related bank accounts, with the events that are the object of the bets, all classified within the same website,

.—Betting house. (betting 1, betting 2, betting N), each with its connection device to the bettors, connection to the banks and connection to the events that are the object of the bets, all within the same website,

Betting house's bank,

.—Bettor's account in the bank

.—The betting grounds are not necessarily found within the joint website

The joint website has the following functions, provided by the main interrelated elements:

A.—Membership into system,

B.—bettor database,

C.—On-line betting databases,

D.—tipsters, team bet, chats,

E.—personalized advice for each client,

F.—legal, technical and financial assistance

And these items for users mean:

1.—informs the bettor of all your bets and live events.

2.—informs the bettor of the different modes and types of use and alerts.
End, limit and timer

3.—The bettor does not need to see the event live, so he does not need to have two devices open

4.—It also reports live bets lost or won.

5.—It is not necessary to bet to use the device

6.—Constant report of the evolution of the day of profit or loss. It is very useful to quantify profits, losses or if at any time of the day you are covered and there are profit options

7.—It brings together the investment in the different bookmakers, with deposits and withdrawals, profit and losses.

8.—Legal assistance, the device supports the client, according to legal possibilities

9.—User help chat in case of possible problems

10.—Report and personalized study of the bettor's bets, to achieve greater success

11.—User chat, exchange opinions with other investors within the device

12.—Management of important notices: notices of suspended bets, Rule 4, bets whose odds go up or down, platforms that have fallen, time to sell your bet, cover yourself, evolution of combined, houses that offer better guaranteed odds and registration bonuses ,

13.—Avoid having your account limited, since by working with several betting houses you can choose the one with the best conditions.

14.—It allows you to create your betting approach or method, bank, stake . . . etc.

15.—Possibility of publicizing proven forecasters and their results,

16.—Possibility to connect with any smart device.

17.—Allows you to gather your own team of forecasters

18.—Offers events and tipsters launch.

Having sufficiently described the nature of the invention, as well as the way of putting it into practice, it should be noted that the provisions indicated above and represented in the attached drawings are susceptible to detailed modifications as long as they do not alter their fundamental principles, established in the paragraphs above and summarized in the following claims.

1. An arrangement of interconnected electronic elements that guide and help within the online betting market comprising
At least one or more users, called bettors (bettor 1, bettor 2, bettor 3, bettor N), each with a connection device to a betting's house, and a related bank accounts, with events that are the object of the bets, all classified within the same website,
a betting house. (betting 1, betting 2, betting N), each with its connection device to the bettors, connection to the banks and connection to the events that are the object of the bets, all within the same website,
a betting house's bank,
an account in the bank for the bettor/s,
wherein these elements are connected between them and there is
a joint website that has the following functions, provided by the main interrelated elements:
A—membership into system,
B—bettor database,
C—on-line betting databases,
D—tipsters, team bet, chats,
E—personalized advice for each client,
F—legal, technical and financial assistance.
